(19) United States
(12) Patent Application Publication
(10) Pub. No.: US 2026/0079851 A1
(43) Pub. Date: Mar. 19, 2026

(54) Restrictions on Address Translations based on Thread Private Indicator and Thread Address Range

(71) Applicant: Apple Inc., Cupertino, CA (US)

(72) Inventors: Jeff Gonion, Campbell, CA (US); Georgia Kouveli, Fulbourn (GB); Bernard J. Semeria, Palo Alto, CA (US); Alexander Donald Charles Chadwick, Cambridge (GB)

(21) Appl. No.: 19/324,592

(22) Filed: Sep. 10, 2025

(30) Foreign Application Priority Data
Sep. 18, 2024 (GR) 20240100636

(51) Int. Cl. G06F 12/14

(52) U.S. Cl. CPC G06F 12/145; G06F 12/1441; G06F 12/1491

(57) ABSTRACT

Techniques are disclosed relating to access control for threads executed by a computer processor. Processor circuitry may include an execution pipeline, a base register and a limit register. The base register and the limit register may define a range of virtual addresses for a thread executed by the execution pipeline. Control circuitry may access a translation table that stores translation entries that map a virtual address space to a physical address space, wherein a given entry includes a thread-private state indication. for a virtual address provided by the thread at a first permission level, the control circuitry may: determine that the thread-private state indication of a corresponding entry of the translation table is set and in response to the determination, provide a translation of the virtual address only if the virtual address falls within the range of virtual addresses.

The present application claims priority to Greek Patent App. No. 20240100636, entitled “Restrictions on Address Translations based on Thread Private Indicator and Thread Address Range,” filed Sep. 18, 2024, the disclosure of which is incorporated by reference herein in its entirety.

### BACKGROUND

### Technical Field

This disclosure relates generally to computer processors and more particularly to thread memory access permissions.

### Description of Related Art

Computer processors, also known as central processing units (CPUs), are the core components of computing devices that perform a wide range of computational tasks. These circuits (referred to as processor circuits) are responsible for executing instructions within the processor circuit's instruction set architecture (ISA), managing data, and controlling the overall operation of a computer system. Processor circuits are found in various devices, including personal computers, laptops, smartphones, servers, and embedded systems, powering the functionality and performance of these devices.

Some instructions in a processor circuit's ISA may be reserved for execution at a specific privilege level, which is typically determined at the time the instruction is executed. Most software executes at a relatively lower privilege (e.g., least privilege), preventing the software from accessing and/or updating critical processor state and other protected resources (thus helping ensure security in the system). In many cases, such software cannot execute instructions that are restricted to more privileged software. Parts of the operating system that do access/change such state, on the other hand, may therefore have more privilege. The number of privilege levels and the instructions that can be executed at each privilege level varies from ISA to ISA.

Permissions play a crucial role in the functioning of processor circuits. A processor circuit's ability to execute tasks efficiently and securely relies on the concept of permissions. Permissions determine what actions and resources are accessible to different components within a system, ensuring the integrity, confidentiality, and availability of data and functionalities. By enforcing permissions, processor circuits ensure that only authorized entities can perform specific operations or access sensitive data, protecting against unauthorized or malicious activities.

Current computer processor circuits typically execute with address translation enabled: the addresses of instructions fetched by the processors and the data addresses accessed by memory-accessing instructions such as loads and stores are virtual addresses, which are then mapped to physical addresses that actually identify the physical memory locations storing the instructions and data. The mapping is performed at a specified granularity, commonly referred to as a “page.” A set of software-managed page tables define the virtual-to-physical address mapping at the page granularity. A virtual address is used to locate an entry in the page table with the physical page number for the page. The least significant bits of the virtual addresses define an offset within a page and are not translated. After translation, the remaining virtual address bits are replaced by a physical page number. Address translation of the sort provided by a page table provides isolation between different programs running on the same system. It also permits the use of a virtual address space larger than the physical address space by paging data in and out of backing storage of various types (e.g., non-volatile storage, disk drives, solid state drives, etc.). In addition, address translation allows for memory protection at the page level of granularity.

### BRIEF DESCRIPTION OF DRAWINGS

FIG. 1 is a block diagram illustrating an example processor that includes access control circuitry for address translations, according to some embodiments.

FIG. 2 is a diagram illustrating an example range, within a virtual address space, indicated by base and limit registers, according to some embodiments.

FIG. 3 is a flow diagram illustrating an example procedure for enforcing a thread-private indicator and address range, according to some embodiments.

FIG. 4 is a diagram illustrating example encodings for guarded and thread-private page indicators, according to some embodiments.

FIG. 5 is a diagram illustrating example fields of base and limit registers, according to some embodiments.

FIG. 6 is a flow diagram illustrating an example method, according to some embodiments.

FIG. 7 is a block diagram illustrating an example processor circuit that may be implemented on one or more integrated circuits (ICs), according to some embodiments.

### DETAILED DESCRIPTION

An application executing on a processor circuit may contain code from many disparate origins, including shared libraries, malloc, a dynamic linker/loader, application logic, user interface (UI) code, etc. Such code may execute in some instances as separate threads of the application. For runtime-compiled or just-in-time (JIT) scenarios, code to be executed may come from input code, a JIT compiler, a JIT validator, or a JIT output region. For a kernel of an operating system, this code may include memory management code, other kernel code, and kernel-mode drivers.

For security reasons, it is frequently desired to isolate or “sandbox” these disparate components by enforcing certain restrictions on their operation and interaction. For example, it may be desired that only malloc code should be able to read/write malloc metadata; only JIT validator code can write to the JIT output region; shared libraries can only read/write the heap regions of the software component that called them, etc.

Traditionally, a thread may inherit access privilege of its spawning process. This could be problematic, however, if one thread were to unintentionally or maliciously modify another thread's private data such as stack data.

Therefore, in disclosed embodiments, thread-private permission indications (e.g., in a page table) may be used, in conjunction with address range information, to provide privacy for thread data in various contexts. Specifically, memory management unit (MMU) circuitry may check a requested virtual address before providing a translation. If the translation entry for the requested virtual address has a thread-private indication and the address is not in the range corresponding to the requesting thread, the MMU may trigger a permission fault.

In some embodiments, for a single process that includes multiple threads of execution that share a virtual address (VA) space, there may be threads each executing interpreted code from different sources. Disclosed techniques may advantageously avoid one of the threads corrupting or leaking values from the stack, or some other private data, of another peer thread.

In some embodiments, all pages of the VA space are annotated with a flag in the translation table that indicates whether the data is in use as a stack or private heap. A given central processing unit (CPU) or core may include a base register and a limit register that may be programmed by more-privileged software to indicate the stack and private heap bounds for the currently-scheduled thread. Any access made by the thread to a stack page that is outside its base-plus-limit bounds may be prevented. Note that disclosed techniques may apply regardless of whether the affected memory regions are used for a stack or for some other thread-local state.

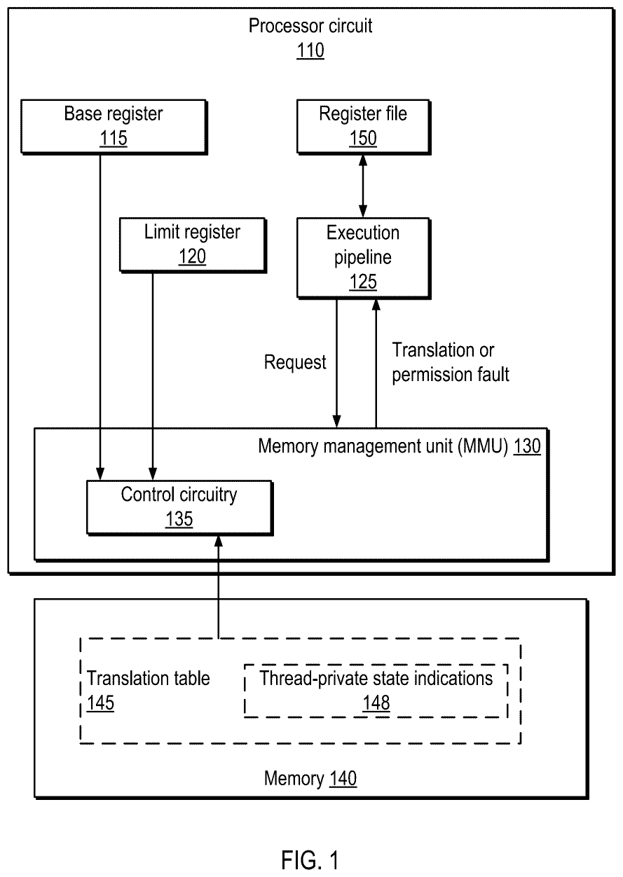

FIG. 1 is a block diagram illustrating an example processor that includes access control circuitry for address translations, according to some embodiments. In the illustrated example, a computing system includes processor circuit 110 and memory 140.

Processor circuit 110, in the illustrated example, includes base reciter 115, limit register 120, execution pipeline 125, memory management unit (MMU) 130, and register file 150. As discussed in detail below, MMU 130 may check thread-private state indications 148 in translation table 145 and verify that translations (requested by a thread executed by execution pipeline 125) for thread-private entries are within a range of addresses specified by base register 115 and limit register 120.

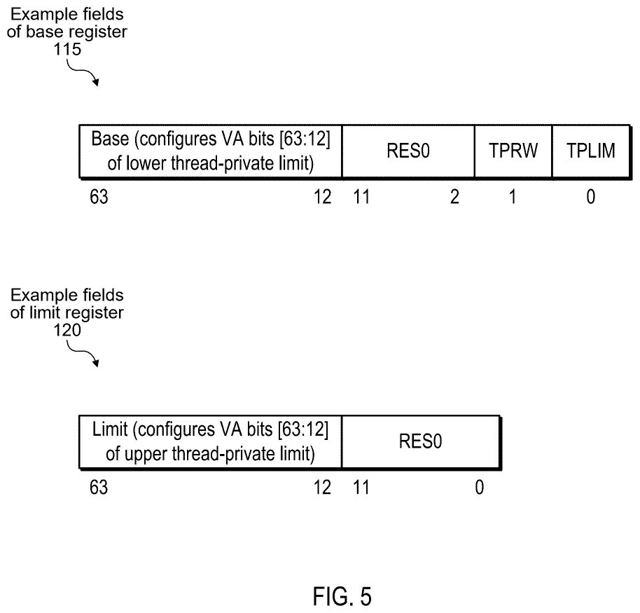

Execution pipeline 125, in some embodiments, is configured to execute program instructions of one or more threads. Execution pipeline 125 may include various pipeline stages, such as fetch, decode, dispatch, arithmetic or load/store stages, write-back, etc. As shown, execution pipeline 125 may access registers in register file 150 during execution. Execution pipeline 125 may also access various special-purpose registers, which may include base register 115 and limit register 120. Example encodings for base register 115 and limit register 120 are shown in FIG. 5 and discussed in detail below.

In some embodiments, processor circuit 110 is a core of a multi-core processor and is configured to execute a single thread at a time. A more-privileged thread may configure the base register 115 and limit register 120 to specify a range of addresses for the currently executing thread. These registers may be saved when the currently executed thread is context switched out and restored when the thread is context switched back in. The more-privileged thread may also configure translation table 145. Note that thread private state checking may be supported at multiple different exception levels, e.g., at EL0 and at EL1/EL2.

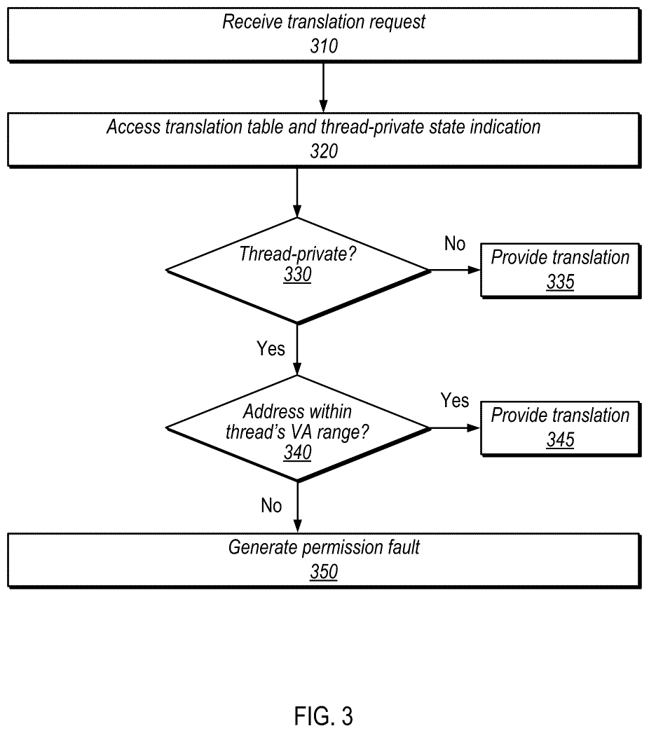

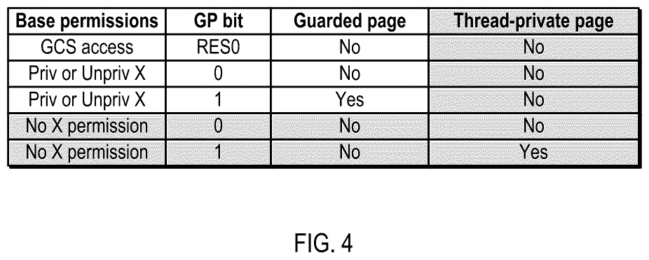

Memory management unit 130, in some embodiments, is configured to provide translations or permission faults for translations requested by execution pipeline 125. In the illustrated example, control circuitry 135 is configured to constrain access to translations based on values from base register 115, limit register 120, and thread-private state indications 148. Specifically, control circuitry 135 may prevent access to thread-private memory regions that are outside of a given thread's range of addresses defined by the base and limit registers 115 and 120. Example techniques and encodings implemented by control circuitry 135 are discussed below with reference to FIGS. 3 and 4.

Memory 140, in some embodiments, is a dynamic random-access memory (DRAM). Note that a given device may implement a memory hierarchy with various levels of caches or memories, some of which may be virtually addressed and others of which may be physically addressed. Memory 140 may be any appropriate level of such a hierarchy. In some embodiments, memory 140 is a system memory.

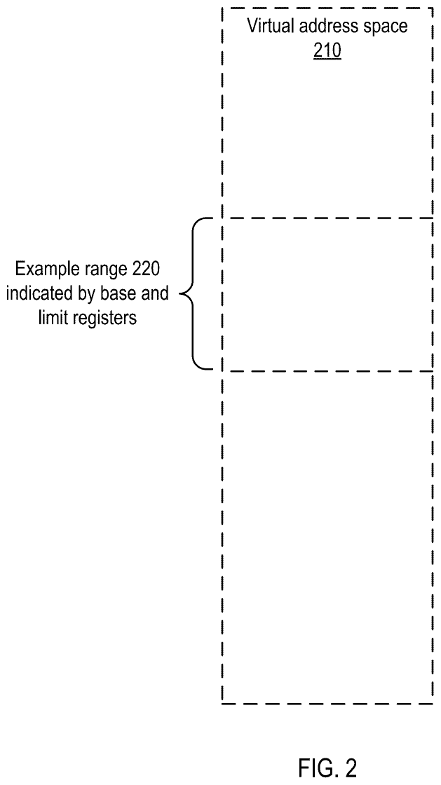

FIG. 2 is a diagram illustrating an example range, within a virtual address space, indicated by base and limit registers, according to some embodiments. In the illustrated example, virtual address space 210 includes a range 220 of virtual addresses. For example, base register 115 may indicate the beginning of the range and limit register 120 may indicate the end of the range. In some embodiments, accesses to translations marked as thread-private are allowed only if the provided virtual address falls within range 220.

FIG. 3 is a flow diagram illustrating an example procedure for enforcing a thread-private indicator and address range, according to some embodiments. At 310, in the illustrated example, MMU 130 receives a translation request from a thread (where the request includes all or a portion of a virtual address). At 320, MMU 130 accesses translation table 145 and the thread-private state indication for the corresponding entry. For example, the translation table 145 may include one or more tables of a page table hierarchy. In some scenarios, MMU 130 may access a cached version of the translation table, e.g., in a translation lookaside buffer (TLB).

At 330, in the illustrated example, control circuitry 135 determines whether the entry associated with the provided virtual address has a thread-private indicator. If not, flow proceeds to 335 and MMU 130 provides the translation (e.g., a physical address mapped to the virtual address). If the entry has a thread-private indicator at 330, flow proceeds to 340 and control circuitry 135 determines whether the provided virtual address is within the thread's virtual address range (e.g., defined by the base and limit registers). If so, MMU provides the translation at 345.

If the address is not within the thread's virtual address range, flow proceeds to 350 and control circuitry 135 generates a permission fault (and does not provide the translation). This may prevent the thread from accessing the physical address associated with the provided virtual address. Further, the processor circuit 110 may take various appropriate actions based on the permission fault. In some embodiments, the permission fault is reported with higher priority than all other permission faults.

FIG. 4 is a diagram illustrating example encodings for guarded and thread-private page indicators, according to some embodiments. In some embodiments, for a given stage 1 translation, the guarded page (GP) bit for a region of memory resolved by a block or page descriptor is interpreted in conjunction with the base permissions for the region, as shown. In the illustrated example, the base permission column indicates the base permissions for an executing thread and the guarded page bit is a translation table bit that may be used for the thread-private indication. Note that the first row in the example of FIG. 4 is for guarded control stack (GCS) accesses.

The guarded page column and thread-private page column indicate, for a given combination of base permissions and GP bit, whether or not the page is guarded or thread-private. In particular, the page is a guarded page, in the illustrated example, if the GP bit is set and the base permissions are privileged execute or unprivileged execute. The page is thread-private, in this example, if the base permissions are “no execute” and the GP bit is set. As discussed above, if the page is thread-private, control circuitry 135 may check the range indicated by the base and limit registers to determine whether the thread is allowed to perform the requested access.

FIG. 5 is a diagram illustrating example fields of base and limit registers, according to some embodiments. The base register 115, in this example, includes a base field in bits 63:12 that configures the upper VA bits of the lower thread-private limit. In this example, bits 11:2 are reserved0, bit 1 is a TPRW field and bit 0 is TPLIM field.

TPLIM, in this example, indicates whether checking of accesses to thread-private memory is enabled. For example, if the TPLIM bit is not set, control circuitry 135 may not restrict translations based on the thread-private indicators (said another way, no accesses may be prevented by this mechanism in this scenario).

TPRW, in this example, controls whether thread-private checking applies to both read and write accesses. For example, a value of 0 may indicate that thread-private checks apply to write accesses only while a value of 1 may indicate that thread-private checks apply to both read and write accesses.

The limit register 120, in this example, includes a limit field in bits 63:12 that configures the upper thread-private limit while bits 11:0 are reserved0. In some embodiments, the base and limit values are not permitted to be cached in a TLB.

### Example Method

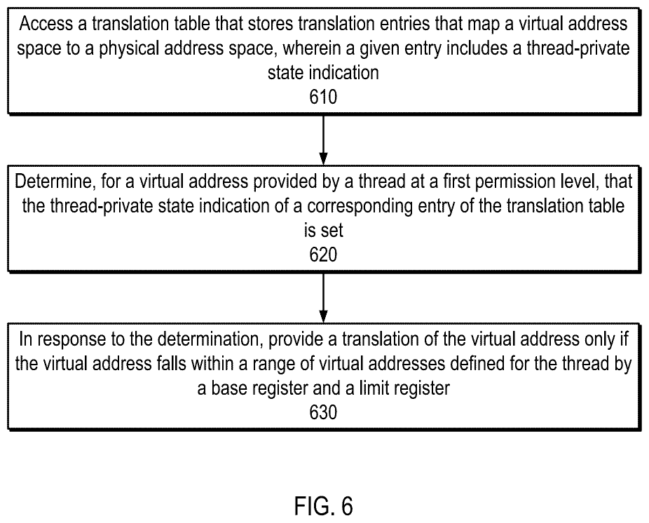

FIG. 6 is a flow diagram illustrating an example method, according to some embodiments. The method shown in FIG. 6 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 610, in the illustrated embodiment, a computing system accesses a translation table that stores translation entries that map a virtual address space to a physical address space, where a given entry includes a thread-private state indication.

At 620, in the illustrated embodiment, the computing system determines, for a virtual address provided by the thread at a first permission level, that the thread-private state indication of a corresponding entry of the translation table is set. The system may store an indication of whether the thread-private state indication applies to write accesses only or to both read and write accesses. The system may simultaneously execute threads with interpreted code from different sources on different processor cores. The first permission level may be a no-execute permission level.

At 620, in the illustrated embodiment, in response to the determination, the computing system provides a translation of the virtual address only if the virtual address falls within a range of virtual addresses defined for the thread by a base register and a limit register. For example, the system may not provide the translation and may generate a permission fault in response to: a value of the thread-private state indication that indicates access is restricted to the range of virtual addresses and a determination that the virtual address does not fall within the range of virtual addresses. The system may provide the translation in response to a value of the thread-private state indication that indicates access is not restricted. The system may provide the translation in response to: a value of the thread-private state indication that indicates access is restricted to the range of addresses and a determination that the virtual address provided by the thread falls within the range of virtual addresses.

The system may execute a more-privileged thread to store values in the base register and the limit register to define the range of virtual addresses. The system may include a limit register and base register for a given thread executed by a given processor core. The system may retrieve values for the base register and the limit register during a context switch operation for the thread. The system may be configured not to cache values from the base register or the limit register in a translation lookaside buffer.

The system may check thread-private state fields and virtual address ranges for multiple exception levels.

In some embodiments, a non-transitory computer-readable medium has instructions stored thereon that are executable by a computing device to perform operations that include: setting a thread-private state indication in an entry of a translation table that stores translation entries that map a virtual address space to a physical address space and storing values in a base register and a limit register to define a range of virtual addresses for a thread. In some embodiments, the setting and the storing configure processor circuitry such that, for a virtual address provided by the thread at a first permission level, the processor circuitry provides a translation of the virtual address only if the virtual address falls within the range of virtual addresses. In some embodiments, the operations further include executing a fault handler to process a permission fault, where the permission fault is generated based on: a value of the thread-private state indication that indicates access is restricted to the range of virtual addresses and a determination that the virtual address does not fall within the range of virtual addresses.

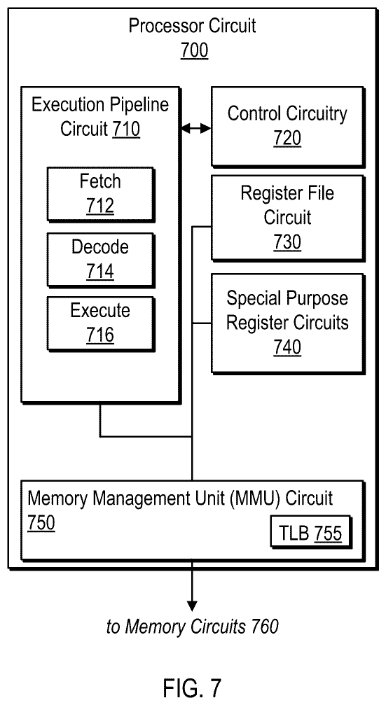

FIG. 7 is a block diagram of one embodiment of a processor circuit that may be implemented on one or more integrated circuits (ICs). As depicted, processor circuit 700 includes execution pipeline circuit 710, control circuitry 720, register file circuit 730, special purpose register circuits 740, and memory management unit (MMU) circuit 750. Processor circuit 700 is configured to perform instructions included in any suitable instruction set architecture (ISA). For example, processor circuit 700 may be configured to perform instructions included in ARM's ArmV9 ISA.

Execution pipeline circuit 710 is representative of circuitry within processor circuit 700 designed to retrieve instructions from memory, and then decode and execute them. Execution pipeline circuit 710 may include any number of stages, but only three exemplary stages are illustrated in FIG. 7. Fetch stage circuit 712, in one embodiment, is configured to issue memory requests to retrieve instructions. In some embodiments, fetch stage circuit 712 may include pre-fetch circuitry to issue memory requests based on predicted next-fetch addresses. Instructions received via the issued memory requests may be stored in an instruction cache (not pictured) within processor circuit 700. Decode stage circuit 714, in one embodiment, is configured to parse instructions received by fetch stage circuit 712 in order to perform decode operations that prepare the instructions to be processed by execute stage circuit 716. For example, decode stage circuit 714 may be configured to determine, from a retrieved instruction, a type of the instruction, a number of its operands, and whether data corresponding to the operands is currently available within processor circuit 700. Decode stage circuit 714 may be configured to place decoded, ready-to-execute instructions in an instruction buffer (not shown) for access by execute stage circuit 716. Execute stage circuit 716, in one embodiment, may retrieve a ready-to-execute instruction from an instruction buffer and perform the instruction using any associated operands. “Performing” the instructions may constitute different actions depending on the type of instruction. Some execution unit circuits within execute stage circuit might be able to totally complete the instructions, such as in the case of a register operation. Other execution units might initiate execution of an instruction, such as a load-store instruction in which a portion of the memory hierarchy is accessed. Operands of the instruction that reference memory locations may thus be loaded as part of execution by a load-store execution unit circuit, and stored in a data cache (not pictured).

In various embodiments, execute stage circuit 716 may perform instructions in a same order as the instructions were fetched (e.g., in-order processing) or may be capable of changing an order of the instructions to improve processor efficiency (e.g., out-of-order processing). Although execute stage circuit 716 is shown as a single block, in some embodiments, execute 716 may include a plurality of execution units, such as an integer/Boolean unit, a floating-point unit, a load-store unit, and the like. Execution pipeline circuit 710 may be configured to process one program thread at a time or multiple threads in an overlapping (e.g., time-sliced) manner.

Control circuitry 720 is configured to perform various processor control operations related to execution of instructions using execution pipeline circuitry 710. These control operations include exception handling, context switches, packet transmission, etc. For example, control circuitry 720 may be configured to generate an exception based on a variety of inputs.

Register file circuit 730 includes a set of registers that may be used to store operands for various instructions of pipeline 710. Such registers are commonly called “general purpose registers,” or GPRs. Register file circuit 730 may include registers of various data types, based on the type of operand execution pipeline circuit 710 is configured to store in the registers (e.g., integer, floating point, multimedia, vector, etc.). Register file 730 may directly implement architectural registers or may implement rename circuitry to map architectural registers to physical registers.

Special purpose register circuits 740, in one embodiment, are registers within processor circuit 700 that are configured to store specific types of values. These register circuits 740 stand in contrast to registers of register file 730, which may be used by any instruction executing on processor 700. Examples of special purpose register circuits 740 include the program counter (PC), instruction register (IR), stack pointer (SP), status register (flags register), and various other control registers.

MMU circuit 750 is configured to act as an interface between processor circuit 700 and memory located on memory circuit 760. For example, MMU circuit 750 may issue memory requests to a memory hierarchy that includes memory circuit 760. In one embodiment, MMU circuit 750 is coupled to a memory bus interface to perform read and write operations with memory circuit 760, including retrieving instructions and other information and storing information related to execution of program threads performed by execution pipeline circuit 710.

Furthermore, MMU circuit 750 may receive memory requests from execute stage circuit 716 (e.g., from a load-store unit circuit) and fetch stage circuit 712. In some embodiments, MMU circuit 750 may be coupled to a plurality of execution pipeline circuits, such as may be included in a core complex. Note that additional memory (not pictured) may be located on processor circuit 700. Note that MMU circuit 750 is commonly configured to receive memory requests that specify virtual addresses. In such embodiments, MMU circuit 750 may be configured to use translation lookaside buffer (TLB) 755 to cache translation information to translate a received virtual address into a physical address corresponding to a particular location in memory circuit 760. Notably, MMU circuit 750 may also be configured to evaluate and enforce permissions related to various instructions in pipeline 710. In one example implementation, MMU circuit 750 may deny a particular memory request if corresponding permissions are not enabled for a received virtual address specified by a memory-accessing instruction.

Memory circuit 760 includes one or more memory circuits within a system memory coupled to processor circuit 700. Although illustrated as a single block, memory circuit 760 may include a plurality of memory blocks. Such blocks may include various types of memory including, but not limited to, dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, memory circuit 760 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with an SoC or an integrated circuit in a chip-on-chip configuration, a package-on-package configuration, or a multi-chip module configuration.

In some embodiments, the elements of processor circuit 700 shown in FIG. 7 may constitute a single processor core. In other embodiments, the depicted elements constitute one of multiple processor cores within processor circuit 700. In still other embodiments, the depicted circuitry may be part of a one or multiple core complexes, with each complex including a plurality of cores sharing support circuitry such as cache and/or branch prediction circuits (not illustrated).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to. ”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or”is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on. ”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom-designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
processor circuitry that includes:
an execution pipeline;
a base register and a limit register, wherein the base register and the limit register define a range of virtual addresses for a thread executed by the execution pipeline; and
control circuitry configured to:
access a translation table that stores translation entries that map a virtual address space to a physical address space, wherein a given entry includes a thread-private state indication; and
for a virtual address provided by the thread at a first permission level:
determine that the thread-private state indication of a corresponding entry of the translation table is set; and
in response to the determination, provide a translation of the virtual address only if the virtual address falls within the range of virtual addresses.

2. The apparatus of claim 1, wherein the control circuitry is configured not to provide the translation and is configured to generate a permission fault in response to:
a value of the thread-private state indication that indicates access is restricted to the range of virtual addresses; and
a determination that the virtual address does not fall within the range of virtual addresses.

3. The apparatus of claim 1, wherein the control circuitry is configured to provide the translation in response to a value of the thread-private state indication that indicates access is not restricted.

4. The apparatus of claim 1, wherein the control circuitry is configured to provide the translation in response to:
a value of the thread-private state indication that indicates access is restricted to the range of addresses; and
a determination that the virtual address provided by the thread falls within the range of virtual addresses.

5. The apparatus of claim 1, wherein the processor circuitry is configured to execute a more-privileged thread to store values in the base register and the limit register to define the range of virtual addresses.

6. The apparatus of claim 1, wherein the processor circuitry is configured to retrieve values for the base register and the limit register during a context switch operation for the thread.

7. The apparatus of claim 1, wherein the processor circuitry is configured to simultaneously execute threads with interpreted code from different sources on different processor cores.

8. The apparatus of claim 1, wherein control circuitry is configured to check thread-private state fields and virtual address ranges for multiple exception levels.

9. The apparatus of claim 1, wherein the control circuitry is further configured to store an indication of whether the thread-private state indication applies to write accesses only or to both read and write accesses.

10. The apparatus of claim 1, wherein the first permission level is a no-execute permission level.

11. The apparatus of claim 1, wherein the control circuitry is configured not to cache values from the base register or the limit register in a translation lookaside buffer.

12. The apparatus of claim 1, wherein the processor circuitry includes multiple processor cores that include a limit register and base register for a given thread executed by a given processor core.

13. A method, comprising:
accessing, by a computing system, a translation table that stores translation entries that map a virtual address space to a physical address space, wherein a given entry includes a thread-private state indication;
accessing, by the computing system, a base register and a limit register to determine a range of virtual addresses for a thread executed by an execution pipeline;
for a virtual address provided by the thread at a first permission level, the computing system providing a translation of the virtual address in response to both:
determining that the thread-private state indication of a corresponding entry of the translation table is set; and
determining that the virtual address falls within the range of virtual addresses.

14. The method of claim 13, further comprising:
for a second virtual address provided by the thread at the first permission level, the computing system generating a permission fault in response to:
a value of the thread-private state indication that indicates access is restricted to the range of virtual addresses; and
a determination that the virtual address does not fall within the range of virtual addresses.

15. The method of claim 13, further comprising:
executing, by the computing system, a more-privileged thread to store values in the base register and the limit register to define the range of virtual addresses.

16. The method of claim 13, further comprising:
retrieving, by the computing system, values for the base register and the limit register during a context switch operation for the thread.

17. The method of claim 13, further comprising:
simultaneously executing multiple threads, including the thread, wherein the multiple threads include interpreted code from different sources on different processor cores.

18. The method of claim 13, further comprising:
storing an indication of whether the thread-private state indication applies to write accesses only or to both read and write accesses.

19. A non-transitory computer-readable medium having instructions stored thereon that are executable by a computing device to perform operations comprising:
setting a thread-private state indication in an entry of a translation table that stores translation entries that map a virtual address space to a physical address space; and
storing values in a base register and a limit register to define a range of virtual addresses for a thread;
wherein the setting and the storing configure processor circuitry such that, for a virtual address provided by the thread at a first permission level, the processor circuitry provides a translation of the virtual address only if the virtual address falls within the range of virtual addresses.

20. The non-transitory computer-readable medium of claim 19, wherein the operations further comprise:
executing a fault handler to process a permission fault, wherein the permission fault is generated based on:
a value of the thread-private state indication that indicates access is restricted to the range of virtual addresses; and
a determination that the virtual address does not fall within the range of virtual addresses.
